(19) United States
(12) Patent Application Publication
(10) Pub. No.: US 2024/0421848 A1
(43) Pub. Date: Dec. 19, 2024

(54) FREQUENCY HOPPING

(71) Applicant: SAT-COM (PTY) LTD, Windhoek (NA)

(72) Inventors: Maarten VENTER, Windhoek (NA); David Kenneth BROWN, Windhoek (NA)

(21) Appl. No.: 18/698,570

(22) PCT Filed: Sep. 20, 2022
(86) PCT No.: PCT/IB2022/058878

§ 371 Date: Apr. 4, 2024

(30) Foreign Application Priority Data
Oct. 6, 2021 (GB) 2114303.7

(51) Int. Cl. H04B 1/7143; H04B 1/7156

(52) U.S. Cl. CPC H04B 1/7143; H04B 1/7156

(57) ABSTRACT

A frequency hopping method and associated apparatus and system using the frequency hopping method are described. The frequency hopping method includes obtaining a key value based on or including a current time value obtained from a current time value source. The key value is used to determine a hop frequency value by querying a data structure stored on a storage medium for a value associated with the key value. The data structure includes a plurality of values, each of which having been generated from a truly random process such that there is no mathematical relationship between the values. A carrier frequency of a transceiver module is set to the hop frequency value for transmitting and receiving radio signals using the carrier frequency.

### CROSS-REFERENCE(S) TO RELATED APPLICATIONS

This application claims priority from United Kingdom patent application number 2114303.7 filed on 6 Oct. 2021, which is incorporated by reference herein.

### FIELD OF THE TECHNOLOGY

This technology relates to spread spectrum techniques using frequency hopping, including a frequency hopping method and associated apparatus and system using the frequency hopping method.

### BACKGROUND

Frequency hopping, or “frequency-hopping spread spectrum” (FHSS) typically refers to a method of transmitting radio signals by rapidly changing the carrier frequency among many distinct frequencies occupying a large spectral band. The available spectral band may be divided into smaller sub-bands and signals may for example rapidly change their carrier frequencies among the centre frequencies of these sub-bands in a specific or predetermined order. The changes are typically controlled in a manner that is known to both transmitter and receiver only. In this manner, interference at a specific frequency will only affect the signal during a short interval.

FHSS can be useful in avoiding interference and in preventing eavesdropping. In military applications, for example, FHSS signals can be resistant to deliberate jamming, unless the adversary has knowledge of the frequency-hopping pattern. Military radios typically generate the frequency-hopping pattern under the control of a secret key (such as a so-called Transmission Security Key, “TRANSEC” in some applications) that the sender and receiver share in advance.

However, there remain challenges in spread spectrum techniques using frequency hopping, for example including challenges relating to generation of hop frequencies, generation of hop patterns and sequence synchronization.

In an effort to address at least some of these challenges, CN101552623 for example discloses chaotic synchronous realizing method based on GPS. CN104052524 discloses a GPS-assisted fast frequency hopping synchronization method and GB2302482 discloses synchronizing mobile and base communications stations. U.S. Pat. No. 6,909,737 discloses a method and device for transmitting information using varying carrier frequencies by means of a frequency hopping method.

However, vulnerabilities regarding decipherability of hop patterns and challenges relating to sequence synchronisation remain. There is accordingly scope for improvement.

The preceding discussion of the background is intended only to facilitate an understanding of the present invention. It should be appreciated that the discussion is not an acknowledgment or admission that any of the material referred to was part of the common general knowledge in the art as at the priority date of the application.

### SUMMARY

In accordance with an aspect of the technology there is provided a computer-implemented method comprising: obtaining a key value based on or including a current time value obtained from a current time value source; using the key value to determine a hop frequency value by querying a data structure stored on a storage medium for a value associated with the key value, wherein the data structure includes a plurality of values, each of which having been generated from a truly random process such that there is no mathematical relationship between the values; and, setting a carrier frequency of a transceiver module to the hop frequency value for transmitting and receiving radio signals using the carrier frequency.

The plurality of values may be hop frequency values. Alternatively, the plurality of values may be frequency offset values. The method may include using the key value to determine an initial frequency offset value and determining the hop frequency value based on the initial frequency offset value.

The method may include determining the hop frequency value by adding the frequency offset value to, or subtracting the frequency offset value from, a carrier frequency value.

The method may include repeatedly, at a predefined hop interval: determining a next frequency offset value by stepping through the data structure from the initial frequency offset value in a predetermined sequence; and, setting the carrier frequency of the transceiver module to a next hop frequency value based on the next frequency offset value.

The predefined hop interval at which the next carrier frequency is determined may be between 0.001 and 1 seconds.

The method may include repeatedly receiving an updated current time value from the current time value source at a predetermined update interval. The current time value source may be a satellite forming part of a global navigation satellite system (GNSS) and the current time value may be received by a satellite navigation system receiver. The satellite navigation system receiver may repeatedly receive a current time value at the predetermined update interval from one or more satellites. The predetermined update interval may be between 0.5 and 2 seconds. The predetermined update interval may be 1 second.

The method may include receiving a passcode. The passcode may be input by a user via a user interface or may be received from a secure memory. Obtaining the key value may include generating the key value as a function of the current time value and the passcode or a derivative thereof. Otherwise, if a passcode is not used, the current time value is the key value.

The method may be conducted at a communication device, such as a two-way radio.

The storage medium may be a removable storage medium.

The number of values may be determined based on operational requirements. The number of values may be determined such that no single value is required to be used more than once for predefined operational requirements. The values may be single-use values. The data structure may include at least about one hundred thousand values.

In accordance with another aspect of the technology there is provided an apparatus including a memory for storing computer-readable program code and a processor for executing the computer-readable program code, the apparatus comprising: a key value obtaining component for obtaining a key value based on or including a current time value obtained from a current time value source; a frequency hopping component for using the key value to determine a hop frequency value by querying a data structure stored on a storage medium for a value associated with the key value, wherein the data structure includes a plurality of values, each of which having been generated from a truly random process such that there is no mathematical relationship between the values; and, a carrier frequency setting component for setting a carrier frequency of a transceiver module to the hop frequency value for transmitting and receiving radio signals using the carrier frequency.

The plurality of values may be hop frequency values. Alternatively, the plurality of values may be frequency offset values. The frequency hopping component may include an initial frequency offset value determining component for using the key value to determine an initial frequency offset value and a hop frequency value determining component for determining the hop frequency value based on the initial frequency offset value. The hop frequency value determining component may determine the hop frequency value by adding the frequency offset value to, or subtracting the frequency offset value from, a carrier frequency value.

The apparatus may include: a next frequency offset value determining component for determining a next frequency offset value by stepping through the data structure from the initial frequency offset value in a predetermined sequence at a predefined hop interval; and, the carrier frequency setting component may further be for setting the carrier frequency of the transceiver module to a next hop frequency value based on the next frequency offset value.

The predefined hop interval at which the next carrier frequency is determined may be between 0.001 and 1 seconds.

The apparatus may include a current time value component for repeatedly receiving an updated current time value from the current time value source at a predetermined update interval. The current time value source may be a satellite forming part of a global navigation satellite system (GNSS) and the current time value component may form part of a satellite navigation system receiver. The satellite navigation system receiver may repeatedly receive a current time value at the predetermined update interval from one or more satellites. The predetermined update interval may be between 0.5 and 2 seconds. The predetermined update interval may be 1 second.

The satellite navigation system receiver may be a GNSS receiver, such as a global positioning system (GPS) receiver, global navigation satellite system (GLONASS) receiver or the like. In one embodiment, the satellite navigation system receiver is a GPS receiver and the current time value is a current GPS time value.

The apparatus may include a passcode receiving component for receiving a passcode. The passcode may be input by a user via a user interface or may be received from a secure memory. The key value obtaining component may include a key value generating component for generating the key value as a function of the current time value and the passcode or a derivative thereof. Otherwise, if a passcode is not used, the current time value is the key value.

The apparatus may be a communication device, such as a two-way radio.

The storage medium may be a removable storage medium and the apparatus may include an interface for receiving and connecting to the removable storage medium.

The number of values may be determined based on operational requirements. The number of values may be determined such that no single value is required to be used more than once for predefined operational requirements. The values may be single-use values. The data structure may include at least about one hundred thousand values.

In accordance with another aspect of the technology there is provided a system including a plurality of apparatuses as defined above.

In accordance with another aspect of the technology there is provided a computer program product comprising a computer-readable medium having stored computer-readable program code for performing the steps of: obtaining a key value based on or including a current time value obtained from a current time value source; using the key value to determine an initial frequency offset value by querying a data structure stored on a storage medium for a frequency offset value associated with the key value, wherein the data structure includes a plurality of frequency offset values, each of which having been generated from a truly random process such that there is no mathematical relationship between the frequency offset values; and, setting a carrier frequency of a transceiver module to a hop frequency value based on the initial frequency offset value for transmitting and receiving radio signals using the carrier frequency.

Further features provide for the computer-readable medium to be a non-transitory computer-readable medium and for the computer-readable program code to be executable by a processing circuit.

In accordance with another aspect of the technology there is provided a computer-implemented method comprising: obtaining a key value based on or including a current time value obtained from a current time value source; using the key value to determine an initial frequency offset value by querying a data structure stored on a storage medium for a frequency offset value associated with the key value, wherein the data structure includes a plurality of frequency offset values, each of which having been generated from a truly random process such that there is no mathematical relationship between the frequency offset values; and, setting a carrier frequency of a transceiver module to a hop frequency value based on the initial frequency offset value for transmitting and receiving radio signals using the carrier frequency.

In accordance with another aspect of the technology there is provided an apparatus including a memory for storing computer-readable program code and a processor for executing the computer-readable program code, the apparatus comprising: a key value obtaining component for obtaining a key value based on or including a current time value obtained from a current time value source; an initial frequency offset value determining component for using the key value to determine an initial frequency offset value by querying a data structure stored on a storage medium for a frequency offset value associated with the key value, wherein the data structure includes a plurality of frequency offset values, each of which having been generated from a truly random process such that there is no mathematical relationship between the frequency offset values; and, a carrier frequency setting component for setting a carrier frequency of a transceiver module to a hop frequency value based on the initial frequency offset value for transmitting and receiving radio signals using the carrier frequency.

In accordance with another aspect of the technology there is provided a computer program product comprising a computer-readable medium having stored computer-readable program code for performing the steps of: obtaining a key value based on or including a current time value obtained from a current time value source; using the key value to determine an initial frequency offset value by querying a data structure stored on a storage medium for a frequency offset value associated with the key value, wherein the data structure includes a plurality of frequency offset values, each of which having been generated from a truly random process such that there is no mathematical relationship between the frequency offset values; and, setting a carrier frequency of a transceiver module to a hop frequency value based on the initial frequency offset value for transmitting and receiving radio signals using the carrier frequency.

Embodiments of the technology will now be described, by way of example only, with reference to the accompanying drawings.

### BRIEF DESCRIPTION OF THE DRAWINGS

In the drawings:

FIG. 1 is a block diagram which illustrates one example embodiment of an apparatus implementing a frequency hopping method according to aspects of the present disclosure;

FIG. 2 is a schematic diagram which illustrates an example embodiment of a data structure according to aspects of the present disclosure;

FIG. 3 is a schematic diagram which illustrates an example system implementing a frequency hopping method according to aspects of the present disclosure;

FIG. 4 is a flow diagram which illustrates an example frequency hopping method according to aspects of the present disclosure; and,

FIG. 5 is a flow diagram which illustrates an example embodiment of a method for generation of hop frequencies according to aspects of the present disclosure.

### DETAILED DESCRIPTION WITH REFERENCE TO THE DRAWINGS

Aspects of the present disclosure relate to spread spectrum techniques using frequency hopping, for example including one or more of arrangements for generation of hop frequencies, arrangements for generation of hop patterns, and arrangements for sequence synchronization. In particular, aspects of the present disclosure relate to a frequency hopping method and associated apparatus and system using the frequency hopping method.

In an example frequency hopping method conducted by an apparatus, a key value based on or including a current time value obtained from a current time value source is obtained. The current time value source may be external to the apparatus executing the method. The current time value source may be arranged such that multiple apparatuses in the field all receive the same current time value at the same point in time. The current time value may be in the form of a time vector. In one embodiment, the current time value source includes a satellite, for example forming part of a global navigation satellite system (GNSS). The key value is used to determine an initial frequency offset value by querying a data structure stored on a storage medium for a frequency offset value associated with the key value.

The data structure includes a plurality of frequency offset values, each of which having been generated from a truly random process such that there is no mathematical relationship between the frequency offset values. In some embodiments, the storage medium is a removable storage medium, such as a non-volatile memory card. In other embodiments, the storage medium is internal to the apparatus and is not removable. The storage medium may for example be provided by a solid state drive (SSD) or other suitable medium.

A carrier frequency of a transceiver module is set to a hop frequency value which is based on the frequency offset value for transmitting and receiving radio signals using the carrier frequency.

Frequency values generated from a truly random process such that there is no mathematical relationship between the frequency offset values should be distinguished from values generated from a pseudo-random process using an algorithm, such as a pseudorandom number generator (PRNG) or deterministic random bit generator (DRBG) in which there is a mathematical relationship between the values (e.g., by virtue of the algorithm). Truly random numbers may be generated through noise floor sampling or as a function of a current value of any other physical environment attribute that is constantly changing in a manner that is practically impossible to model. Such values may therefore have no known, precise or continuous mathematical relationship between each other.

Use of such a data structure may improve transmission security because the hopping pattern cannot be determined without access to the data structure. For example, the hopping pattern cannot be analysed to determine the sequence of frequency offset values because of the truly random manner in which the values are generated.

Using a removable storage medium may facilitate secure distribution of new data structures. A passcode may be used as an input for generating the key value to further improve transmission security, mitigate the risk of the data structure falling into enemy hands and to facilitate use of the same data structure by multiple teams or units without causing communication interference.

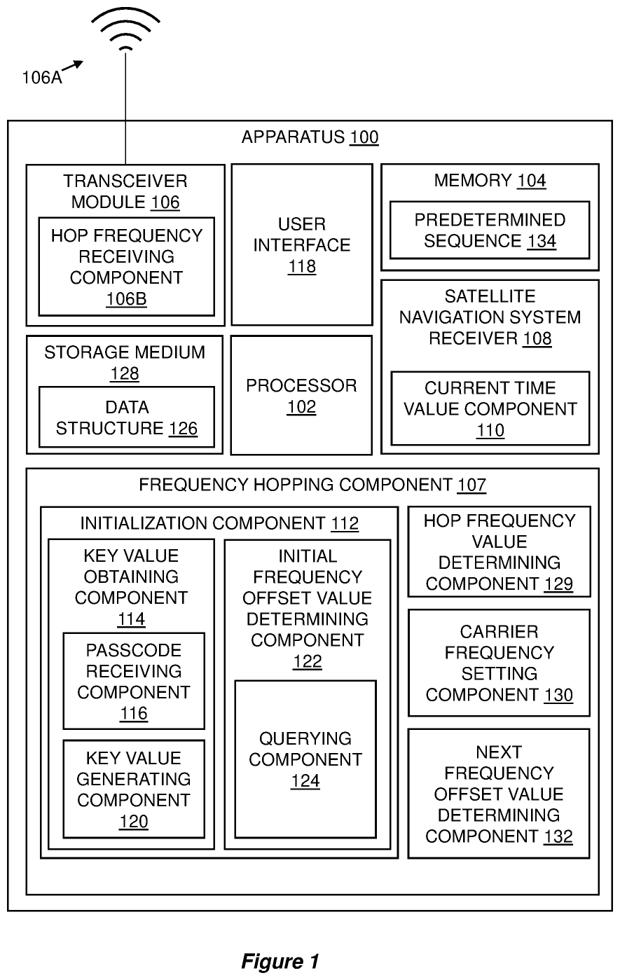

FIG. 1 is a block diagram which illustrates one example embodiment of an apparatus (100) implementing a frequency hopping method according to aspects of the present disclosure. The apparatus may be a communication device, such as a two-way radio.

The apparatus (100) may include a processor (102) for executing the functions of components described below, which may be provided by hardware or by software units executing on the apparatus (100). The software units may be stored in a memory component (104) and instructions may be provided to the processor (102) to carry out the functionality of the described components.

The apparatus further includes a transceiver module (106) and frequency hopping component (107) for using a key value to determine a hop frequency value by querying a data structure stored on a storage medium for a value associated with the key value.

The transceiver module (106) may be configured to transmit and receive radio waves using an antenna (106A) for communication purposes. The transceiver module (106) may be configured to transmit and receive radio waves at radio frequency. For example, the transceiver module may be configured to transmit and receive radio waves within one or more of the following operating frequency ranges: low frequency (30-300 kHz); medium frequency (300 kHz-3 MHZ); high frequency (3-30 MHZ); very high frequency (30-300 MHZ); ultra high frequency (300 MHZ-3 GHz); super high frequency (3-30 GHZ); extremely high frequency (30-300 GHZ); and the like. In one example embodiment, the transceiver module may be configured to operate within one or both of the following frequency ranges: 30-170 MHz and 1.6-512 MHz. The transceiver module (106) transmits and receives the radio waves using a carrier frequency within the relevant operating frequency range. The carrier frequency changes repeatedly at a predefined hop interval, determined based on a hop rate. The transceiver module (106) may be configured to query or receive an updated hop frequency value from the frequency hopping component (107) at the hop interval, in response to an interrupt or other event, or the like. Hop widths may be in the range of 100 kHz, to 100 MHz or wider (e.g., in the case of a direct conversation receiver). In some embodiments, hop widths may be selectable from a predefined range of widths, for example including 100 kHz, 1 MHZ, 2 MHZ, 5 MHZ, 10 MHz, 20 MHz and 40 MHz. In some embodiments, the hop rate and hop interval could also vary dynamically according to an algorithm that is synchronised to a time vector (for example being the current time value).

The transceiver module (106) may for example include a hop frequency receiving component (106B) configured to receive the hop frequency value from the frequency hopping component (107) and to set the carrier frequency to the hop frequency value.

In the illustrated embodiment, the apparatus (100) includes a satellite navigation system receiver (108). The satellite navigation system receiver (108) may be configured to receive signals from one or more satellites, typically to provide autonomous geo-spatial positioning. The signals may be time signals transmitted along a line of sight by radio from the satellites. The signals may include a time value generated by an atomic clock. The time value may be based on a uniformly counting time scale beginning at a predetermined date and counting in seconds (or in weeks and seconds of a week). The signals may therefore allow the receiver (108) to calculate the current local time to high precision, which allows time synchronisation. The satellite navigation system receiver (108) may be configured repeatedly to receive or determine a current time value (corresponding to the current time) at a predetermined update interval, for example being between 0.5 and 2 seconds. The satellite navigation system receiver (108) may provide access to the current time value via a current time value component (110) to other modules or components of the apparatus. The satellite navigation system receiver (108) may for example be provided by any suitable GNSS receiver, such as a global positioning system (GPS) receiver, GLONASS receiver or the like. In one example embodiment, the satellite navigation system receiver is a GPS receiver, the current time value is a current GPS time value (e.g. represented as a whole number, such as 1303734431, which corresponds to Apr. 29, 2021, 12:26:53 UTC) and the predetermined update interval is 1 second.

In other embodiments, the apparatus may receive the current time value from another current time value source. For example, in another embodiment, the current time value source may be a long range navigator (LORAN) transmitter, the apparatus may include a LORAN receiver and the current time value may be or may be based on a time LORAN.

In another embodiment, for example, the apparatus may implement over-the-air synchronisation by which a current time value may be generated by one apparatus and synchronized with other apparatuses in the field either over the radio interface or over an electrical interface. In such an embodiment, the current time value component may include a current time value generator and a current time value synchronization component. The current time value synchronization component may have access to an oscillator which outputs a periodic, oscillating electronic signal usable by the current time value synchronization component in maintaining time synchronisation.

The current time value synchronization component may be configured: to use the current time value generated by the current time value generator to synchronize other apparatuses; and, to receive the current time value from another apparatus having generated the current time value. In such an embodiment, the predetermined update interval may for example be in the range of a few minutes to a few hours or more. In some embodiments, for example, the predetermined update interval may for example be 48 hours.

In such an embodiment, the time source may be internal for an apparatus that generates the time value or external for an apparatus that receives the time value from another apparatus via the respective current time value synchronization components.

In some embodiments, the apparatus includes a satellite navigation system receiver as well as a current time value generator and a current time value synchronization component. In such an embodiment, the apparatus may be configured to switch to over-the-air synchronization in response to detecting jamming of satellite navigation system signals.

The frequency hopping component (107) may be configured to synchronize the frequency hopping sequence of the apparatus (100) with that of other apparatuses in the field. The frequency hopping component (107) may include an initialization/synchronization component (112) arranged to determine an initial frequency offset value.

The initialization component (112) may include a key value obtaining component (114) arranged to obtain a key value based on or including a current time value obtained from the current time value component (110). In the illustrated embodiment, the key value obtaining component (114) includes a passcode receiving component (116) arranged to receive a passcode. The passcode may be input into the apparatus via a user interface (118) thereof or may be retrieved from, for example, a secure memory that can be programmed to update the passcode from time to time. The key value obtaining component (114) includes a key value generating component (120) configured to generate the key value as a function of the time value and one or more of: the hop rate; the size, in a number of bits or bytes, of the frequency offset value; and optionally the passcode (or a derivative, e.g. hash, thereof). The function may be any suitable function, such as an addition, subtraction, multiplication, concatenation, AND, OR, XOR, or any combination thereof, or the like. In one example embodiment, the function is: [“time value”×“hop rate”×“number of bytes used for frequency calculation”]+passcode. The number of bits or bytes may determine the resolution and the rate at which the data structure is traversed.

In other embodiments, other functions may be used. In some embodiments, the function may be configured or selected to output a value having the same length (i.e. the same number of digits) as the current time value. The function may be arranged such that only a predefined subset of the digits of the current time value are altered (e.g. the first few least significant digits). If no passcode is input or available, or if no passcode functionality is provided, the key value may be the time value.

The initialization component (112) may include an initial frequency offset value determining component (122) arranged to determine an initial frequency offset value. The initial frequency offset value determining component (122) may be configured to use the key value to determine the initial frequency offset value. The initial frequency offset value determining component (122) may include a querying component (124) configured to query a data structure (126) stored on a storage medium (128).

The storage medium (128) may be a removable storage medium, and the apparatus may include an interface for receiving and connecting to the removable storage medium. The interface includes contact elements for electrical connection to and communication between the apparatus and the storage medium. The removable storage medium may for example be in the form of a non-volatile memory card, a USB flash drive or the like. In other embodiments, the storage medium is internal to the apparatus (e.g. in the form of an SSD, or the like).

The data structure (126) may include a plurality of frequency offset values. The number of frequency offset values stored will depend on customer and/or operational requirements and available storage size. The number of frequency offset values may be determined based on operational requirements, such as the hop rate, estimated time in the field, estimated mission duration and the like. In particular, the number of frequency offset values may be determined such that no single frequency offset value is required to be used more than once for predefined operational requirements. Predefined operational requirements may for example include a requirement that the data structure must provide at least one day's, one week's, one month's, etc. worth of frequency offset values, at a predefined maximum hop rate, or the like. In this manner, in some implementations, the frequency offset values may be single-use values, each of which may be read and used only once. It is anticipated that practical implementations of the present disclosure will require in the region of at least one hundred thousand (100,000) frequency offset values stored in the storage medium. For a typical hop rate, one hundred thousand frequency offset values may provide a sufficient number of values for one day's use in the field, before having to change the key, change the storage medium, or the like. The upper bound of the number of frequency offset values is expected to be limited by practicalities, such as the amount of available storage. However, implementations in which at least one million or even several million frequency offset values stored in the storage medium are anticipated.

Each of the frequency offset values is generated from or using a truly random process such that there is no mathematical relationship between the frequency offset values in the data structure. The randomly generated values may for example be generated using a hardware random number generator (HRNG) or true random number generator (TRNG) that generates random numbers from a physical process (such as noise floor sampling, or the like). In one example embodiment, each randomly generated value is an 8-digit integer value. It should however be appreciated that in other embodiments, each of the randomly generated values may have a longer or shorter length. For example, the length may be scalable up to 2∧256 binary numbers depending on the frequency accuracy required. Using truly random numbers ensures that there is no mathematical relationship between one frequency offset value in the data structure and the next. In some embodiments, instead of storing frequency offset values, the data structure may store truly randomly generated carrier frequency values. Storing frequency offset values may, however, reduce storage space requirements of the data structure.

In one example embodiment, the data structure is in the form of an array, list or vector of truly random numbers. In such an embodiment, each of the random numbers is stored in a memory location associated with a memory address and the key value may correspond or otherwise map to a memory address from which to retrieve the frequency offset value.

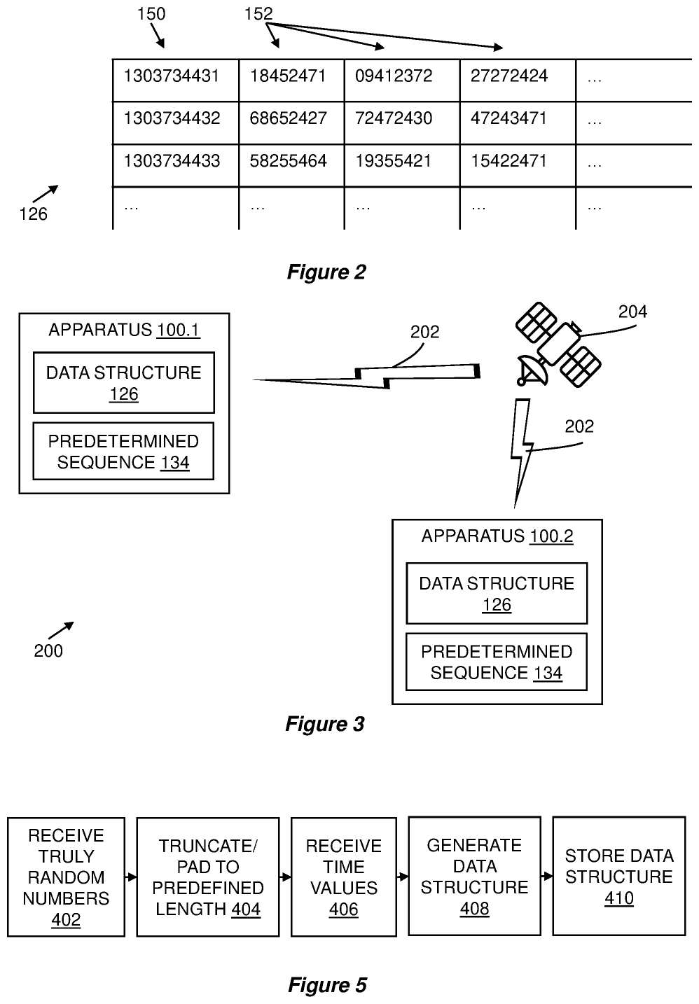

In another example embodiment, and referring now to FIG. 2, the data structure (126) may be a table. The first column (150) of the table may include key values which are based on expected time values. The key values may for example begin with a time value that corresponds to a point in time that is just before expected use of the table and may increment by one going down the column. The table may include one additional column (152) for each hop in the current time value update interval. For example, if the predefined update interval of the current time value is 1 second, and if a hop rate of 600 hops per second needs to be supported, the table may include an additional 600 columns. The rows of each of these additional columns may store randomly generated values. The randomly generated values may be generated using a truly random process, as described above.

Each of the frequency offset values in the data structure is therefore associated with a key value. In some embodiments, the data structure may have enough random numbers to support at least three months' worth of unique frequency offset values at a hop rate of 600 hops per second. The data structure may for example have more than 7.7 million rows and 1,000 columns for this purpose (to support a hop rate of 1,000 hops per second for 90 days). If each frequency offset value is 4 bytes, 32 GB of storage will be sufficient to store 3 months' worth of values. The time dependent nature of the key value and the truly random nature of the frequency offset values ensures that there is little to repetition of frequency offset values or little to no repetition of a sequence of frequency offset values.

The data structure may be associated with an expiry, corresponding approximately to a time and date represented by the last key value in the data structure. For example, in an embodiment in which the GPS time values are used, if the last key value is 1638388800, the expiry time and date of the data structure may be approximately Dec. 1, 2021, 20:00:00 UTC. After expiry, the data structure can be destroyed and replaced with another one.

In other embodiments, the data structure may take on other forms. The data structure may for example be in the form of a database (such as in the form of a key-value store or any other suitable storage paradigm). In some embodiments, multiple frequency values may be associated with a key value or derivative thereof in another way. For example, in some embodiments, where there are multiple frequency hops per update interval, each of the key values in the data structure may have an associated decimal value (e.g. 1303734431.001, 1303734431.002 and so on) each of which being associated with a frequency offset value. The decimal values may be increments of one over the hopping rate. In such an embodiment, the data structure may then include key values including the decimalised time values (in increments of one over the hopping rate), each of which is associated with a corresponding frequency offset value.

Returning to FIG. 1, the querying component (124) may be configured to query the data structure (126) for a frequency offset value associated with the key value. This may for example include finding one or more entries in the data structure which correspond to the key value. In the case of the data structure being in the form of an array, list or vector of truly random numbers, querying the data structure may include mapping the key value to a memory address or memory location from where to retrieve the frequency offset value. In the case of the data structure being a table, querying the data structure may include searching the table for a row the first column of which has a value that corresponds to the key value and then reading the value in the next column of the same row for setting as the frequency offset value. Initialisation and synchronization may be tied to the predefined update interval, such that synchronisation must wait until an updated current time value is received and then a frequency offset value from the first column of frequency offset values is always retrieved. Other arrangements may also be implemented.

The frequency hopping component (107) may include a hop frequency value determining component (129) arranged to determine a hop frequency value based on the frequency offset value (e.g. by adding the frequency offset value to, or subtracting it from a carrier frequency value). In some embodiments, the data structure stores randomly generated carrier values and the hop frequency value determining component may use the carrier frequency value obtained from the table as the hop frequency value.

The frequency hopping component (107) may include a carrier frequency setting component (130) configured to set a carrier frequency of the transceiver module (106) to the hop frequency value based on the frequency offset value for transmitting and receiving radio signals using the carrier frequency. This may include providing the hop frequency value to the hop frequency receiving component (106B) of the transceiver module (106).

The frequency hopping component (107) may include a next frequency offset value determining component (132). The next frequency offset value determining component (132) may be configured to determine a next frequency offset value at a predefined hop interval. The hop interval may for example be selected from the range of: 0.001 or lower to 1 seconds (corresponding to a hop rate of between 1,000 times per second or more to once every second).

In some embodiments, the frequency hopping component may provide a configurable hop rate selectable from one or more of the following rates: 1, 2, 5, 10, 20, 50, 100, 200, 400 and 600 hops per second.

The next frequency offset value determining component (132) may be configured to determine a next frequency offset value by stepping through the data structure (126) from the initial frequency offset value in a predetermined sequence (134) stored in a portion of the memory (104) accessible to the frequency hopping component (107) (or in its own memory). For example, in the case of the data structure being a vector or list, the predetermined sequence (134) may include stepping sequentially through the vector or list from one value to the next. The predetermined sequence may move in a forward direction and can wrap to the beginning if the key was issued in the middle of the relevant time period. For example, in the case of the data structure being a table with one column with for each hop per time interval, the predetermined sequence (134) may be column-by-column and row-by-row (i.e. along the column from left to right and then on to the next row). Other predetermined sequences may be used (e.g. every second value, every second column, every second row, etc.).

The next frequency offset value determining component (132) may be configured to use the hop frequency value determining component (129) to determine a next hop frequency value based on the next frequency offset value. The next frequency offset value determining component (132) may be configured to use the carrier frequency setting component (130) to set the carrier frequency of the transceiver module (106) to a hop frequency value based on the next frequency offset value.

In an example system (200) including a plurality of geographically separated apparatuses (100.1, 100.2), e.g. as illustrated in FIG. 3, each apparatus (100.1, 100.2) has its own copy of the same data structure (126) and each apparatus has access to the same predetermined sequence (134). Each apparatus (100.1, 100.2) has access to a current time value from a current time value source via its current time value component such that the apparatuses are able to synchronize to the same hop frequency at any point in time at which they chose to initiate transmission or reception of radio signals. The current time value obtained from the current time value component (110) of each apparatus may include or be based on a time signal (202) received from a satellite (204) or other suitable current time value source.

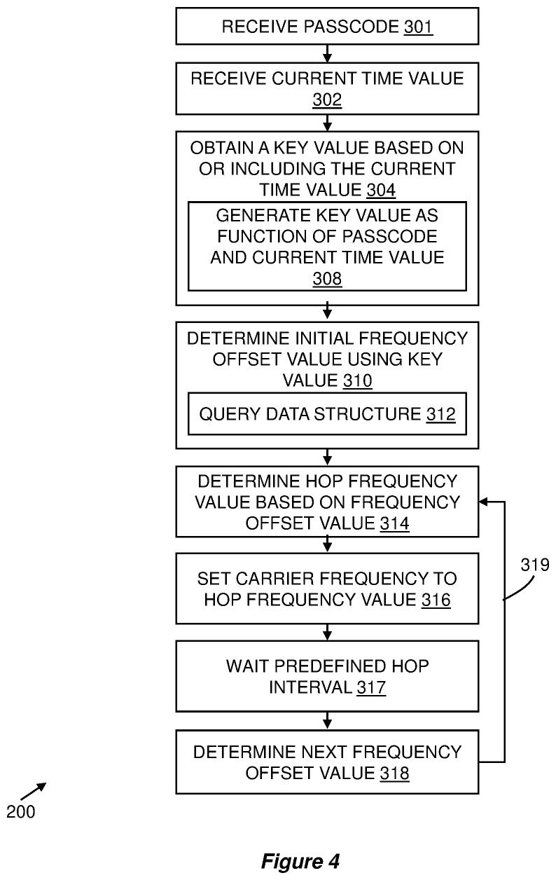

The apparatus (100) and system (200) described above may implement a frequency hopping method. An example frequency hopping method according to aspects of the present disclosure is illustrated in the flow diagram of FIG. 4. The method may be conducted by an apparatus. The apparatus may be a communication device, such as a two-way radio.

In some embodiments or in some cases, the method may include receiving (301) a passcode (such as a PIN, password, etc.). The passcode may be input by a user via a user interface of the apparatus or may be received from a secure memory.

The method may include receiving (302) a current time value. The current time value may be received repeatedly at a predetermined update interval. In cases where a passcode is input or is retrieved, the next current time value may be the current time value that is received and used for initialisation and synchronization. The current time value may be received (or derived from information received from) a current time value source such that each of a plurality of apparatuses in the field receives or derives the same current time value at the same point in time. In one embodiment, the current time value source may be external, such as a satellite (e.g. forming part of a GNSS) which transmits a time signal at a predetermined, fixed update interval (e.g. every half second, every second, every two seconds or the like). In some embodiments, a satellite navigation system receiver repeatedly receives the current time value at the predetermined update interval. In another embodiment in which over-the-air synchronisation is used, the current time value source is a current time value generator or current time value synchronisation component which synchronizes the current time with other apparatuses in the field.

The method includes obtaining (304) a key value based on or including the current time value. If a passcode is received, obtaining the key value may include generating (308) the key value as a function of the time value and the passcode or a derivative thereof. The passcode allows for multiple units in the field, each of which has a plurality of apparatuses and each using their own passcode, to use the same data structure at the same time without interference. The passcode adds a further layer of security should the data structure fall into enemy hands. If a passcode is not received (e.g. in embodiments in which a passcode is not supported, or in use cases where a passcode is not used), the current time value is used as the key value.

The method may include using the key value to determine a hop frequency value by querying a data structure stored on a storage medium for a value associated with the key value. The data structure includes a plurality of values, each of which having been generated from a truly random process such that there is no mathematical relationship between the values. The plurality of values may be hop frequency values. Alternatively, and in the illustrated embodiment, the plurality of values are frequency offset values.

The method includes using the key value to determine (310) an initial frequency offset value. This may include by querying (312) a data structure stored on a storage medium for a frequency offset value associated with the key value. The data structure may include a plurality of frequency offset values. Each of the frequency offset values may have been generated from a truly random process such that there is no mathematical relationship between the frequency offset values. In some embodiments, the data structure may for example have enough random numbers to support three months' worth of unique frequency offset values (e.g. if a hop rate of 600 hops per second is used). In other embodiments, the data structure may have enough random numbers to support one day's worth of unique frequency offset values. Of course, if a higher hop rate is used, the frequency offset values may be used more quickly. The truly random nature of the frequency offset values (generated through noise floor sampling, for example), means that there is no mathematical relationship between the frequency offset values.

The method may include determining (314) a hop frequency value based on the frequency offset value (e.g. by adding the frequency offset value to, or subtracting it from a carrier frequency value).

The method includes setting (316) a carrier frequency of a transceiver module of the apparatus to the hop frequency value for transmitting and receiving radio signals using the carrier frequency.

During initialization and synchronization, the method may therefore include setting an initial frequency offset value as being equal to the frequency offset value that is associated with the key value in the data structure and initialising a transceiver module at a frequency equal to a carrier frequency value plus or minus the initial frequency offset value.

After initialization and synchronization, for the purpose of transmitting and receiving communication signals, the method may include waiting (317) for a period of time equal to the predefined hop interval and then determining (318) a next frequency offset value, for example by stepping through the data structure from the initial frequency offset value in a predetermined sequence. The predefined hop interval at which the next carrier frequency is determined may be in the range of between 0.001 and 1 seconds. The method repeats (319) to determine (314) a next hop frequency value based on the next frequency offset value and setting (316) the carrier frequency of the transceiver module to the next hop frequency value.

Of course, in actual implementations of the above described method, unless the context dictates otherwise, some of the steps may be performed in different order, some steps may be performed substantially simultaneously and, depending on implementation, some steps may be omitted.

A frequency hopping apparatus, system and method are described herein. A current time value from a current time value source, which may be an external source, is used to determine a starting position in a data structure containing a plurality of truly random numbers for hop frequency synchronisation. Thereafter, frequency offset values are obtained from the data structure in a predetermined sequence for continual updating of the hop frequency during radio communications. The data structure stores enough probabilistically unique, frequency offset values to support up to, for example, between one day and three months (or more) of use in the field, after which the data structure may expire and should be destroyed. The data structure may be stored on removable storage medium to facilitate swapping data structures.

FIG. 5 is a flow diagram which illustrates an example embodiment of a method for generation of hop frequencies according to aspects of the present disclosure. The method may be conducted by a suitable computing device.

The method includes receiving (402) a stream of truly random numbers from a random number generator, such as an HRNG or TRNG.

The method may include truncating or padding (404) the truly random numbers to a predefined length (e.g. to 8 digits to provide a stream of 8-digit integers).

The method may include receiving or generating (406) a stream of consecutive time values corresponding to times and dates in the future. This may include incrementing an initial time value corresponding to a predetermined time and date in the future according to a predefined update interval. The time values may be represented as integers. In some embodiments, the time values may be GPS time values.

The method includes generating (408) a data structure including the truly random numbers. This may include generating a data structure in which batches of the truly random numbers (e.g. up to one thousand) are associated with each of the time values. Each batch of truly random numbers may have a number of values corresponding to an inverse of a minimum predetermined hop interval (corresponding to a predetermined maximum hop rate).

The method includes storing (410) the data structure on one or more storage mediums for distribution and use in the field. The method may include associating the data structure with an expiry date indicating a last possible date of use of the data structure.

A frequency hopping system and method for the generation of hop frequencies, the generation of hop patterns and sequence synchronization across multiple communication devices are thus provided.

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

For example, the system, apparatus and method may be implemented using a current time value from any suitable current time value source which is external to each of the apparatuses in the field and which can provide a highly accurate current time value at regular, predetermine update intervals. Any suitable storage paradigm for the data structure may be used in which each key value is associated with a plurality of frequency offset values. Any suitable manner of obtaining the frequency offset values from the data structure may be used. For example, in some embodiments, querying the data structure for a frequency value associated with a key value may include retrieving all frequency values associated with that key value and storing them in a high-speed memory for rapid access.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method comprising:
obtaining a key value based on or including a current time value obtained from a current time value source;
using the key value to determine a hop frequency value by querying a data structure stored on a storage medium for a value associated with the key value, wherein the data structure includes a plurality of values, each of which having been generated from a truly random process such that there is no mathematical relationship between the values; and,
setting a carrier frequency of a transceiver module to the hop frequency value for transmitting and receiving radio signals using the carrier frequency.

2. The method as claimed in claim 1, wherein the plurality of values are frequency offset values, and wherein the method includes using the key value to determine an initial frequency offset value and determining the hop frequency value based on the initial frequency offset value.

3. The method as claimed in claim 2, including determining the hop frequency value by adding the frequency offset value to, or subtracting the frequency offset value from, a carrier frequency value.

4. The method as claimed in claim 2, including repeatedly, at a predefined hop interval:
determining a next frequency offset value by stepping through the data structure from the initial frequency offset value in a predetermined sequence; and,
setting the carrier frequency of the transceiver module to a next hop frequency value based on the next frequency offset value.

5. The method as claimed in claim 4, wherein the predefined hop interval at which the next carrier frequency is determined is between 0.001 and 1 seconds.

6. The method as claimed in claim 1, including repeatedly receiving an updated current time value from the current time value source at a predetermined update interval.

7. The method as claimed in claim 6, wherein the current time value source is a satellite forming part of a global navigation satellite system (GNSS) and wherein the current time value is received by a satellite navigation system receiver.

8. The method as claimed in claim 7, wherein the predetermined update interval is between 0.5 and 2 seconds.

9. The method as claimed in claim 8, wherein the predetermined update interval is second.

10. The method as claimed in claim 1, including receiving a passcode, and wherein obtaining the key value includes generating the key value as a function of the current time value and the passcode or a derivative thereof.

11. The method as claimed in claim 1, wherein the method is conducted at an apparatus, wherein the apparatus is a communication device.

12. (canceled)

13. The method as claimed in claim 1, wherein a number of values is determined based on operational requirements.

14. The method as claimed in claim 1, wherein a number of values is determined such that no single value is required to be used more than once for predefined operational requirements.

15. The method as claimed in claim 1, wherein the values are single-use values.

16. The method as claimed in claim 1, wherein the data structure includes at least one hundred thousand values.

17. An apparatus including a memory for storing computer-readable program code and a processor for executing the computer-readable program code, the apparatus comprising:
a key value obtaining component for obtaining a key value based on or including a current time value obtained from a current time value source;
a frequency hopping component for using the key value to determine a hop frequency value by querying a data structure stored on a storage medium for a value associated with the key value, wherein the data structure includes a plurality of values, each of which having been generated from a truly random process such that there is no mathematical relationship between the values; and,
a carrier frequency setting component for setting a carrier frequency of a transceiver module to the hop frequency value for transmitting and receiving radio signals using the carrier frequency.

18.-27. (canceled)

28. The apparatus as claimed in claim 17, wherein the storage medium is a removable storage medium and wherein the apparatus includes an interface for receiving and connecting to the removable storage medium.

29.-31. (canceled)

32. The apparatus as claimed in claim 17, wherein the data structure includes at least one hundred thousand values.

33. (canceled)

34. A non-transitory computer storage medium comprising computer-readable instructions, said instructions comprising:
obtaining a key value based on or including a current time value obtained from a current time value source;
using the key value to determine a hop frequency value by querying a data structure stored on a storage medium for a value associated with the key value, wherein the data structure includes a plurality of values, each of which having been generated from a truly random process such that there is no mathematical relationship between the values; and,
setting a carrier frequency of a transceiver module to the hop frequency value for transmitting and receiving radio signals using the carrier frequency.
